(19) United States
(12) Patent Application Publication
(10) Pub. No.: US 2007/0292781 A1
(43) Pub. Date: Dec. 20, 2007

(54) Electrophotographic photoreceptor and image-forming apparatus using the same

(75) Inventors: Hiroshi Sugimura, Osaka (JP); Akihiro Kondoh, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/806,757

(22) Filed: Jun. 4, 2007

(30) Foreign Application Priority Data
Jun. 15, 2006 (JP) 2006-166528

(51) Int. Cl. G03G 15/02

(52) U.S. Cl. 430/58.05; 399/159

(57) ABSTRACT

An electrophotographic photoreceptor comprising a conductive support and a photosensitive layer formed on the conductive support and containing at least a charge generation material and a charge transport material, wherein a surface layer of the photoreceptor contains a polycarbonate copolymer having structural units represented by the following general formulas (1) to (3):

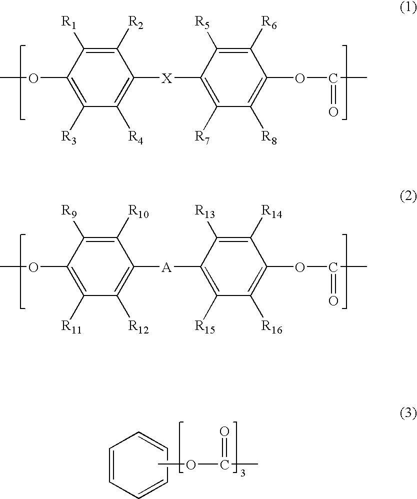

### CROSS-REFERENCE TO RELATED APPLICATION

This application is related to Japanese application No. 2006-166528 filed on Jun. 15, 2006, whose priority is claimed under 35 USC §119, the disclosure of which is incorporated by reference in its entirety.

### BACKGROUND OF THE INVENTION

1. Field of the Invention

The present invention relates to an electrophotographic photoreceptor and an image-forming apparatus using the same. More specifically, the present invention relates to an electrophotographic photoreceptor having a surface layer composed of a specific polycarbonate copolymer, and an image-forming apparatus using the same.

2. Description of the Related Art

In the field of electrophotographic image-forming apparatuses such as copiers, printers, and facsimile machines, polycarbonates are conventionally used for forming a surface layer of an electrophotographic photoreceptor, on which an electrostatic latent image is to be formed, because of their high mechanical strength, and excellent dimensional stability, wear resistance and so forth. In particular, such polycarbonates are frequently used as a binder resin for holding a charge transport material in a charge transport layer that is the outermost layer of a function separation-type electrophotographic photoreceptor obtained by laminating, on a conductive support, a charge generation layer containing a charge generation material and a charge transport layer containing a charge transport material in this order.

As typical polycarbonates, there are known aromatic polycarbonates such as bisphenol A polycarbonate obtained by reacting 4,4′-(1-methylethylidene)bisphenol (bisphenol A) with phosgene and Z-type polycarbonate having high wear resistance and solubility synthesized from 4,4′-cyclohexylidenebisphenol (bisphenol Z). Generally, these polycarbonates are superior in mechanical strength (especially, mechanical strength at a low temperature) and weatherability to other thermoplastic resins.

Such polycarbonates generally used have a linear structure, but a polycarbonate having a branched structure has been also proposed to achieve increased strength (see Japanese Examined Patent Publication No. SHO 44(1969)-17149). Further, attempts have been made to produce electrophotographic photoreceptors using polycarbonates having a branched structure (see Japanese Patent Nos. 2824288, 3445854, 3730634, 3647496, 3402970, and 3738627 and Japanese Unexamined Patent Publication Nos. HEI 7(1995)-181706, HEI 9(1997)-319102, and 2002-121246).

A layer containing a polycarbonate having a branched structure is harder than that containing a polycarbonate having a linear structure, and therefore the amount of reduction in film thickness can be reduced. However, it is known that such a polycarbonate having a branched structure shows low molecular mobility due to steric hindrance, and is therefore inferior in flexibility to a polycarbonate having a linear structure. For this reason, the layer containing a polycarbonate having a branched structure is brittle, and therefore cracks are likely to occur in the layer or the layer is likely to be peeled off due to repeated use of an electrophotographic photoreceptor.

On the other hand, polycarbonates having a linear structure containing an ether structure have been proposed, which are intended to be used for producing a belt-shaped photoreceptor having improved flexibility (see Japanese Patent Nos. 2568352 and 2639073 and Japanese Unexamined Patent Publication No. 2005-266047).

Further, it is known that, among various polycarbonates, a polycarbonate having a cyclic alkylidene structure has particularly high solubility in solvents, and such a polycarbonate is also used for producing an electrophotographic photoreceptor (see Japanese Examined Patent Publication No. HEI 2(1990)-57300).

### SUMMARY OF THE INVENTION

However, these polycarbonates described above are not good enough to satisfy requirements of a binder resin to be used for producing an electrophotographic photoreceptor, and therefore there is a demand for development of polycarbonates having improved properties.

More specifically, there is a demand for development of polycarbonates which can be used as a binder resin for producing a surface layer of an electrophotographic photoreceptor to provide an electrophotographic photoreceptor having the following properties: (1) high mechanical strength, (2) excellent electric characteristics, (3) high charge potential and high sensitivity, (4) little change in various characteristics even after repeated voltage application, irradiation with laser light or the like, toner adhesion, and application of heat and pressure, and (5) stable formation of high-quality images over a long period of time.

The present invention is directed to an electrophotographic photoreceptor comprising: a conductive support; and a photosensitive layer formed on the conductive support and contained at least a charge generation material and a charge transport material, wherein a surface layer of the photoreceptor contains a polycarbonate copolymer having structural units represented by the following general formulas (1) to (3):

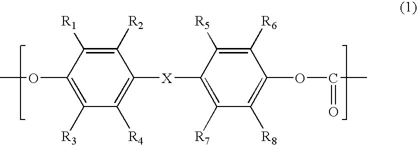

where X is oxygen atom or sulfur atom, R₁ to R₈ are hydrogen atom, a halogen atom, hydroxyl group, or an alkyl group having 1 to 4 carbon atoms;

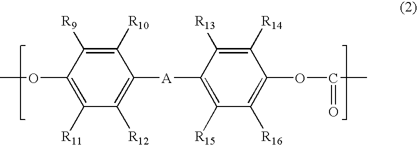

where A is a C₁ to C₁₀ linear, C₂ to C₁₀ branched, or C₃ to C₁₀ cyclic alkylidene group which may have an aryl group as a substituent, or an arylene group, and R₉ to R₁₆ are hydrogen atom, a halogen atom, nitro group, hydroxyl group, or an alkyl group having 1 to 4 carbon atoms; and

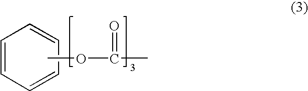

Another aspect of the present invention is directed to an image-forming apparatus comprising: the electrophotographic photoreceptor described above; charging part for charging the electrophotographic photoreceptor; exposure part for forming an electrostatic latent image by irradiating the charged electrophotographic photoreceptor with light in accordance with image information; developing part for developing the electrostatic latent image formed on the electrophotographic photoreceptor into a visible image; and transfer part for transferring the visible image developed by the developing part onto a recording medium.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a cross-sectional view which schematically shows the structure of main part of a single layer-type electrophotographic photoreceptor of the present invention;

FIG. 2 is a cross-sectional view which schematically shows the structure of main part of a single layer-type electrophotographic photoreceptor of the present invention;

FIG. 3 is a cross-sectional view which schematically shows the structure of main part of a single layer-type electrophotographic photoreceptor of the present invention;

FIG. 4 is a cross-sectional view which schematically shows the structure of main part of a single layer-type electrophotographic photoreceptor of the present invention;

FIG. 5 is a cross-sectional view which schematically shows the structure of main parts of a multi-layered type electrophotographic photoreceptor of the present invention;

FIG. 6 is a cross-sectional view which schematically shows the structure of main part of a multi-layered type electrophotographic photoreceptor of the present invention;

FIG. 7 is a cross-sectional view which schematically shows the structure of main part of a multi-layered type electrophotographic photoreceptor of the present invention;

FIG. 8 is a cross-sectional view which schematically shows the structure of main part of a multi-layered type electrophotographic photoreceptor of the present invention;

FIG. 9 is a cross-sectional view which simply shows the structure of an image-forming apparatus of the present invention.

### DETAILED DESCRIPTION OF THE PREFERRED EMBODIMENTS

### (Polycarbonate Copolymer)

An electrophotographic photoreceptor of the present invention contains a polycarbonate copolymer having structural units represented by the following general formulas (1) to (3):

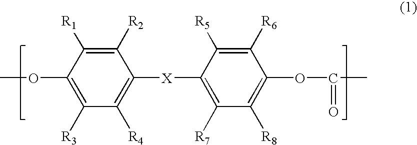

where X is oxygen atom or sulfur atom, and R₁ to R₈ are hydrogen atom, a halogen atom, hydroxyl group, or an alkyl group having 1 to 4 carbon atoms;

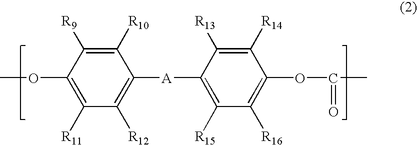

where A is a C₁ to C₁₀ linear, C₂ to C₁₀ branched, or C₃ to C₁₀ cyclic alkylidene group which may have an aryl group as a substituent, or an arylene group, and R₉ to R₁₆ are hydrogen atom, a halogen atom, nitro group, hydroxyl group, or an alkyl group having 1 to 4 carbon atoms; and

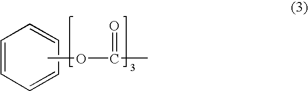

In the general formulas (1) and (2), examples of the halogen atom include fluorine atom, chlorine atom, and bromine atom, and examples of the alkyl group having 1 to 4 carbon atoms include methyl group, ethyl group, n- or i-propyl group, and n-, i-, sec-, or tert-butyl group.

Further, in the general formulas (1) and (2), the substituent groups R₁ to R₁₆ are the same or different.

In the general formula (2), examples of the C₁ to C₁₀ (1 to 10 carbon atom) linear alkylidene group include methylene group, ethylene group, trimethylene group, and decamethylene group, and examples of the C₂ to C₁₀ branched alkylidene group include the above-mentioned linear alkylidene groups having a C₁ to C₄ alkyl group as a side chain (with the proviso that the total number of carbon atoms is at most 10). Specific examples of the C₂ to C₁₀ branched alkylidene group include ethylidene group, isopropylidene group, propylene group, dimethylethylene group, ethylethylene group, and diethylethylene group. In the general formula (2), examples of the C₃ to C₁₀ cyclic alkylidene group include bivalent groups derived from cyclopropane, cyclobutane, cyclopentane, cyclohexane, and cycloheptane. It is to be noted that the cyclic alkylidene group may have single bonds at any positions thereof, but preferably has single bonds on the same carbon.

In the general formula (2), examples of the aryl-substituted alkylidene group include the above-mentioned alkylidene groups having an aryl group as a substituent. Examples of the aryl group include phenyl group and naphthyl group. The aryl group may have a lower alkyl group or a halogen atom as a substituent. Specific examples of the aryl-substituted alkylidene group include phenylmethylene group, diphenylmethylene group, phenylethylene group, and diphenylethylene group.

In the general formula (2), examples of the arylene group include bivalent groups derived from benzene, indene, naphthalene, and fluorene. It is to be noted that the arylene group may have single bonds at any positions thereof.

The phenyl group contained in the structural unit represented by the general formula (3) may have a lower alkyl group or a halogen atom (not shown) as a substituent. The phenyl group may have the carbonyloxy groups at any position thereof, for example, at positions 1, 3, and 5, positions 1, 2, and 3, or positions 1, 2, and 4.

More preferably, the polycarbonate copolymer has a structural unit represented by the general formula (1) wherein X is oxygen atom or sulfur atom and R₁ to R₈ are hydrogen atom, chlorine atom, methyl group, or ethyl group, a structural unit represented by the general formula (2) wherein A is cyclohexylidene group, isopropylidene group, phenylethylidene group, or cyclopentylidene group and R₉ to R₁₆ are hydrogen atom, chlorine atom, methyl group, or ethyl group, and an unsubstituted structural unit represented by the general formula (3).

The ratio among the structural units represented by the general formulas (1) to (3) contained in the polycarbonate copolymer is not particularly limited, but the polycarbonate copolymer preferably contains 5 to 9 mol % of the structural unit represented by the general formula (1), 86 to 94 mol % of the structural unit represented by the general formula (2), and 0.5 to 5 mol % of the structural unit represented by the general formula (3). By using such a polycarbonate copolymer containing the structural units represented by the general formulas (1) to (3) in the above ratio, it is possible to provide an electrophotographic photoreceptor having excellent balance between wear resistance and flexibility. More preferably, the polycarbonate copolymer contains 7 to 9 mol % of the structural unit represented by the general formula (1), 88 to 93 mol % of the structural unit represented by the general formula (2), and 0.5 to 3 mol % of the structural unit represented by the general formula (3). Particularly preferred ratios among the structural units represented by the general formulas (1) to (3) contained in the polycarbonate copolymer are 9/89/2 mol %, 8/90/2 mol %, and 5/93/2 mol %.

The polycarbonate copolymer having the structural units represented by the general formulas (1) to (3) may be a random copolymer, alternating copolymer, block copolymer, random alternating copolymer, or random block copolymer.

The polycarbonate copolymer preferably has a number average molecular weight (Mn) of 5,000 to 500,000. If the Mn of the polycarbonate copolymer is less than 5,000, the strength of an obtained film is lowered. On the other hand, if the Mn of the polycarbonate copolymer exceeds 500,000, the polycarbonate copolymer has low solubility in a solvent used for producing an electrophotographic photoreceptor. The Mn of the polycarbonate copolymer is more preferably in the range of 10,000 to 100,000, even more preferably in the range of 15,000 to 60,000.

In addition, the polycarbonate copolymer preferably has a weight average molecular weight (Mw) of 5,000 to 500,000. If the Mw of the polycarbonate copolymer is less than 5,000, the strength of an obtained film is lowered. On the other hand, if the Mw of the polycarbonate copolymer exceeds 500,000, the polycarbonate copolymer has low solubility in a solvent. The Mw of the polycarbonate copolymer is more preferably in the range of 10,000 to 300,000, even more preferably in the range of 20,000 to 150,000.

It is to be noted that Mn is a polystyrene-reduced number average molecular weight determined by gel permeation chromatography (GPC), and Mw is a polystyrene-reduced weight average molecular weight determined by gel permeation chromatography (GPC).

Specific examples of the polycarbonate copolymer include the following:

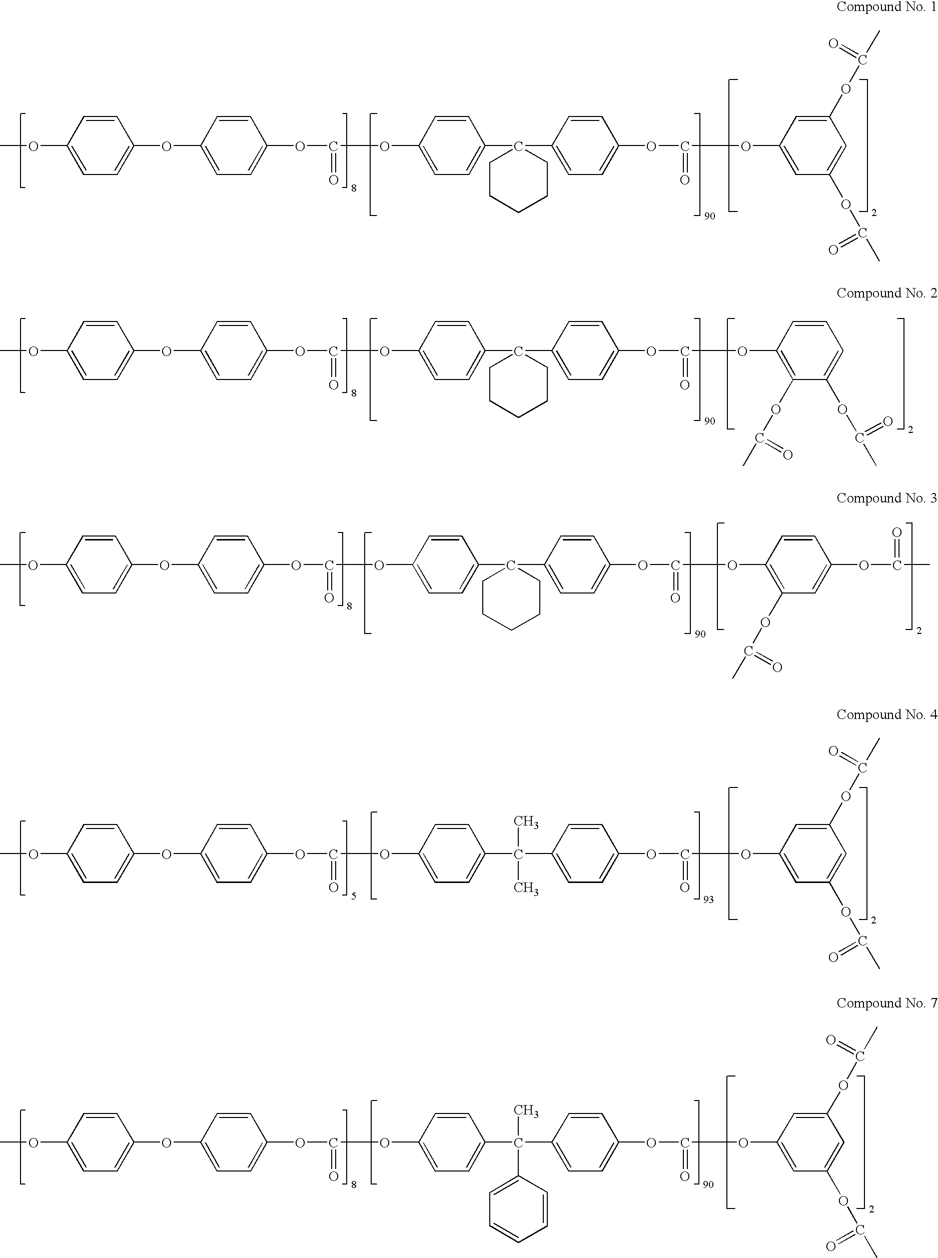

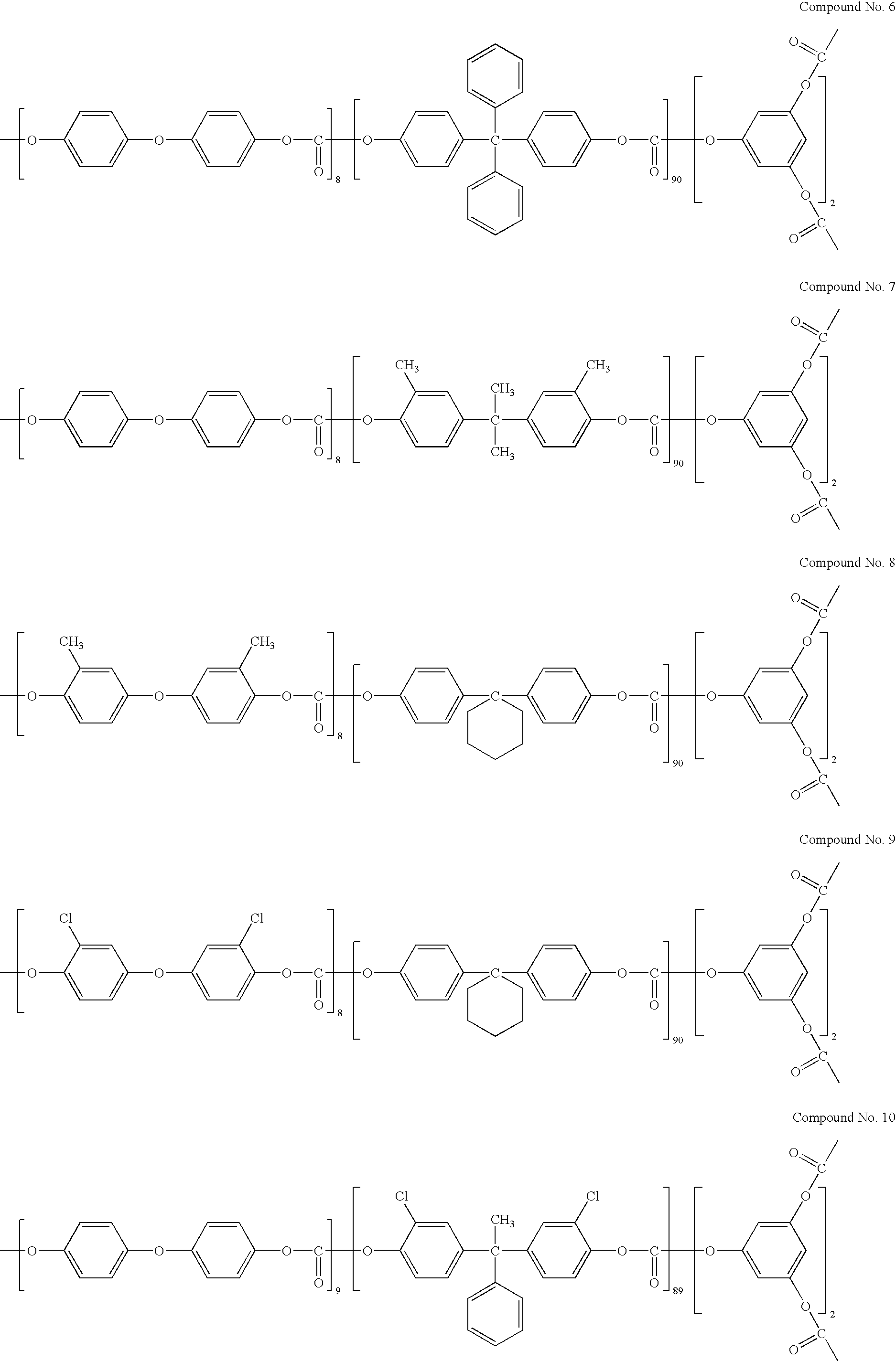

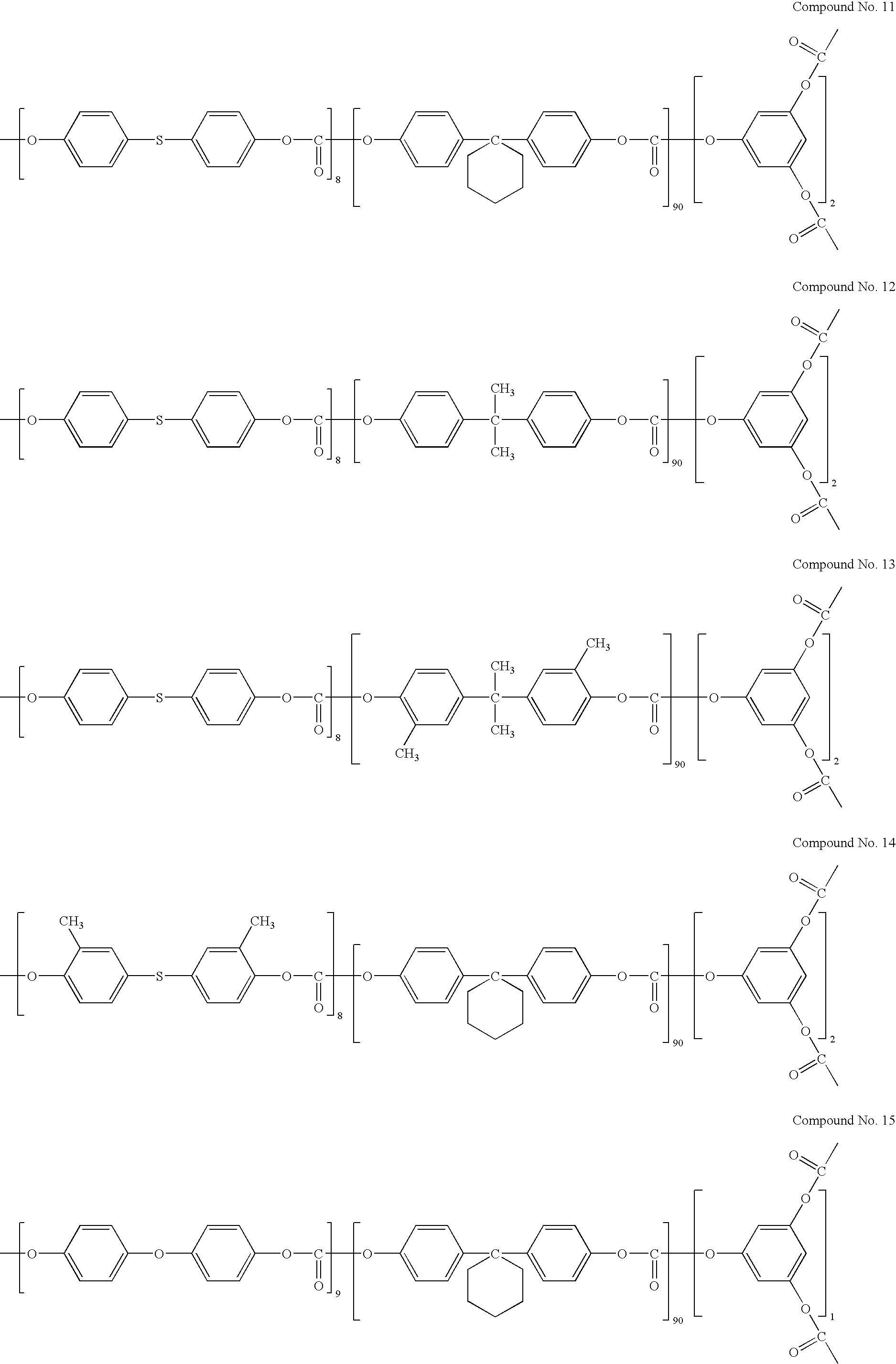

It is to be noted that the end structure of the polycarbonate copolymer is preferably derived from n-butyl p-hydroxybenzoate, n-propyl p-hydroxybenzoate, or ethyl p-hydroxybenzoate.

(Method for Producing Polycarbonate Copolymer)

Monomers corresponding to the structural units represented by the general formulas (1) to (3) to be used for producing a polycarbonate copolymer are not particularly limited, and well-known monomers can be used. As such monomers, a carbonate compound, a dihydroxy compound, and a trihydroxy compound can be used. The trihydroxy compound functions as an agent for obtaining a polycarbonate copolymer having a three-dimensional structure, that is, as a branching agent.

As the carbonate compound, any carbonate compound usually used for producing polycarbonate can be used. Examples of such a carbonate compound include bisaryl carbonates such as bisphenyl carbonate, halogenated formates such as bischloroformate, and halogenated carbonates such as phosgene, trichloromethyl chloroformate (phosgene dimer), bis(trichloromethyl)carbonate (phosgene trimer), and phosgene polymer. It is to be noted that phosgene trimer has an advantage that it is thermally and chemically stable and therefore facilitates reaction control and is easy to handle. The halogenated formates can be derived from dihydroxy compounds described below.

As the dihydroxy compound, a well-known dihydroxy compound can be used without any limitation, as long as it is a monomer corresponding to the structure of the structural unit represented by the general formula (1) or (2) exclusive of carbonyl group. By using such dihydroxy compounds as monomers, it is possible to obtain a polycarbonate copolymer having higher mechanical strength than that of a polycarbonate containing only the structural unit represented by the general formula (2).

Examples of the dihydroxy compound corresponding to the structural unit represented by the general formula (1) include 4,4′-bishydroxyphenyl ether, 3,3′-dimethyl-4,4′-bishydroxyphenyl ether, 3,3′-dichloro-4,4′-bishydroxyphenyl ether, bishydroxyphenyl sulfide, and 3,3′-dimethyl-4,4′-bishydroxyphenyl sulfide. These dihydroxy compounds may be used in combination of two or more of them. Among these dihydroxy compounds, 4,4′-bishydroxyphenyl ether and 3,3′-dimethyl-4,4′-bishydroxyphenyl ether are preferably used from the viewpoint of binding stability.

Examples of the dihydroxy compound corresponding to the structural unit represented by the general formula (2) include 4,4′-(1-methylethylidene)bisphenol, 4,4′-(1-methylethylidene)bis(2-methylphenol), 4,4′-cyclohexylidenebisphenol, 4,4-ethylidenebisphenol, 4,4′-(1,3-dimethylbutylidene)bisphenol, 4,4′-(1-methylethylidene)bis(2,6-dimethylphenol), 4,4′-(1-phenylethylidene)bisphenol, 4,4′-(2-ethylhexylidene)bisphenol, 5,5′-(1-methylethylidene)(1,1′-biphenyl)-2-ol, 1,1′-biphenyl-4,4′-diol, 4,4′-methylidenebisphenol, 4,4′-methylene-bis[2-(2-propenyl)phenol], 4,4′-methylidene-bis(2-methylphenol), 4,4′-propanediylbisphenol, 4,4′-(1-methylpropylidene)bisphenol, 4,4′-(2-methylpropylidene)bisphenol, 4,4′-(3-methylbutylidene)bisphenol, 4,4′-cyclopentylidenebisphenol, 4,4′-(phenylmethylidene)bisphenol, 4,4′-(1-methylheptylidene)bisphenol, 4,4′-cyclohexylidene-bis(3-methylphenol), 4,4′-(1-methylethylidene)bis[2-(2-propenyl)phenol], 4,4′-(1-methylethylidene)bis[2-(1-methylethyl)phenol], 4,4′-(1-methyloctylidene)bisphenol, 4,4′-(1-phenylethylidene)bis(2-methylphenol), 4,4′-cyclohexylidene-bis(2,6-dimethylphenol), 4,4′-(1-methyl)nonylidenebisphenol, 4,4′-decylidenebisphenol, 4,4′-(1-methylethylidene)bis[2-(1,1-methylpropyl)phenol], 4,4′-(1-methylethylidene)bis[2-(1,1-dimethylethyl)phenol], 4,4′-(diphenylmethylidene)bisphenol, 4,4′-cyclohexylidene-bis[2-(1,1-dimethylethyl)phenol], 4,4′-(2-methylpropylidene)bis[3-methyl-6-(1,1-dimethylethyl)phenol], 4,4′-(1-methylethylidene)bis(2-cyclohexylphenol), 4,4′-methylene-bis[2,6-bis(1,1-dimethylethyl)phenol], 4,4′-methylene-bis(2,6-di-sec-butylphenol), 5,5′-(1,1-cyclohexylidene)bis-(1,1′-biphenyl)-2-ol, 4,4′-cyclohexylidene-bis(2-cyclohexylphenol), 2,2′-methylene-bis(4-nonylphenol), 4,4′-(1-methylethylidene)bis[2,6-bis(1,1-dimethylethyl)phenol], 5,5′-(1-phenolethylidene)(1,1′-biphenyl)-2-ol, bis(4-hydroxyphenyl)methanone, 4,4′-methylene-bis(2-fluorophenol), 4,4′-[2,2,2-trifluoro-1-(trifluoromethyl)ethylidene]bisphenol, 4,4′-isopropylidenebis(2-fluorophenol), 4,4′-[(4-fluorophenyl)methylene]bis(2-fluorophenol), 4,4′-(phenylmethylene)bis(2-fluorophenol), 4,4′-[(4-fluorophenyl)methylene]bisphenol, 4,4′-(1-methylethylidene)bis(2-chloro-6-methylphenol), 4,4′-(1-methylethylidene)bis(2,6-dichlorophenol), 4,4′-(1-methylethylidene)bis(2-chlorophenol), 4,4′-methylenebis(2,6-dibromophenol), 4,4′-(1-methylethylidene)bis(2,6-dibromophenol), 4,4′-(1-methylethylidene)bis(2-nitrophenol), 3,3′-dimethyl-1,1′-biphenyl-4,4′-diol, 3,3′,5,5′-tetramethyl-1,1′-biphenyl-4,4′-diol, 3,3′,5,5′-tetra-t-butyl-1,1′-biphenyl-4,4′-diol, 3,3′-difluoro-1,1′-biphenyl-4,4′-diol, and 3,3′5,5′-tetrafluoro-1,1′-biphenyl-4,4′-diol.

These dihydroxy compounds may be used in combination of two or more of them. Among these dihydroxy compounds, 4,4′-(1-methylethylidene)bisphenol, 4,4′-(1-methylethylidene)bis(2-methylphenol), and 4,4′-cyclohexylidenebisphenol are preferably used from the viewpoint of reactivity.

Examples of the trihydroxy compound include 1,3,5-, 1,2,3-, or 1,2,4-trihydroxybenzene, trihydroxy ethyl benzene, trihydroxy n-propyl benzene, and trihydroxy n-butyl benzene. These trihydroxy compounds may be used in combination of two or more of them. Among these trihydroxy compounds, trihydroxybenzene is preferably used because it is easily available and cheap.

A method for polymerization is not particularly limited, and any well-known method can be employed. For example, well-known polymerization methods described in “Plastic Zairyo Koza, Polycarbonate Resin” (written by Mikio Matsukane, Shogo Tahara, and Shuji Kato and published by Nikkan Kogyo Shinbun Sha in 1969) can be employed.

More specifically, in a case where a halogenated carbonate is used as a carbonate compound, interfacial polymerization, solution polymerization, or transesterification can be employed to obtain a polycarbonate copolymer. On the other hand, in a case where a bisaryl carbonate is used as a carbonate compound, transesterification can be employed to obtain a polycarbonate copolymer.

(Interfacial Polymerization)

An aqueous solution containing a monomer composed of a bivalent phenol having an ether bond in the main chain thereof (i.e., a dihydroxy compound corresponding to the general formula (1)), a monomer composed of a bivalent phenol having a cyclic alkylidene structure or the like in the main chain thereof (i.e., a dihydroxy compound corresponding to the general formula (2)), and a monomer composed of a trifunctional organic compound having a phenolic hydroxyl group (i.e., a trihydroxy compound) as a branching agent is prepared as an aqueous phase, and an oil-based solution containing a carbonate compound and a catalyst for producing polycarbonate is prepared as an oil phase. The aqueous phase and the oil phase are mixed to polymerize the monomers at an interface between these two phases to produce a polycarbonate copolymer according to the present invention.

The dihydroxy compounds and the trihydroxy compound can be dissolved in water under alkaline conditions. Water can be alkalified by using a base generally used. As such a base, well-known one can be used, and examples thereof include: hydroxides of alkali metals and alkaline earth metals, such as sodium hydroxide, potassium hydroxide, and calcium hydroxide; and carbonates of alkali metals and alkaline earth metals, such as sodium carbonate, potassium carbonate, calcium carbonate, and sodium bicarbonate. Among these bases, alkali metal hydroxides such as sodium hydroxide and potassium hydroxide are preferably used. These bases can be used singly or in combination of two or more of them. Examples of a medium to be used for preparing the aqueous solution include: water such as distilled water and ion-exchanged water; and mixtures of such water and aqueous media such as alcohols. The amount of the base to be used for alkalifying water is determined so that the entire amount of the dihydroxy compounds and trihydroxy compound used for preparing the aqueous solution can be stably dissolved in water used, and the specific amount of the base to be used can be appropriately adjusted according to the kinds of compounds used and the kind of base used.

As an organic solvent to be used for preparing the oil phase, one usually used in this field, that is, one whose solubility in water is low but does not adversely affect polymerization reaction and which can dissolve a polycarbonate copolymer to be produced can be used. Examples of such an organic solvent include: halogenated aliphatic hydrocarbons such as dichloromethane, 1,2-dichloroethane, 1,2-dichloroethylene, trichloroethane, tetrachloroethane, and dichloropropane; halogenated aromatic hydrocarbons such as chlorobenzene and dichlorobenzene; mixtures of two or more of the halogenated aliphatic hydrocarbons; mixtures of two or more of the halogenated aromatic hydrocarbons; and mixtures of one or more of the halogenated aliphatic hydrocarbons and one or more of the halogenated aromatic hydrocarbons. Among them, dichloromethane and chlorobenzene are preferably used. The organic solvent may be further mixed with one or more hydrocarbons selected from aromatic hydrocarbons such as toluene, xylene, and ethyl benzene and alicyclic hydrocarbons such as hexane and cyclohexane. The amount of the organic solvent to be used is not particularly limited, and is appropriately determined according to the kinds of monomers used, the amounts of monomers used, the kind of organic solvent used, and reaction conditions such as reaction temperature and reaction time so that polymerization reaction can smoothly proceed.

As the catalyst for producing polycarbonate, one usually used in this field can be used. Examples of such a catalyst include tertiary amines, quaternary ammonium salts, tertiary phosphine, quaternary phosphonium salts, nitrogen-containing heterocyclic compounds and salts thereof, imino ethers and salts thereof, and amide group-containing compounds. Among them, tertiary amines are preferably used, tertiary amines having 3 to 30 carbon atoms are more preferably used, and triethylamine is particularly preferably used. The catalyst for producing polycarbonate is added to a reaction system either before or after, or both before and after the addition of the carbonate compound to the reaction system.

The ratio by amounts of the dihydroxyl compound corresponding to the general formula (1), the dihydroxy compound corresponding to the general formula (2), and the trihydroxy compound used is not particularly limited, but is preferably set so that an obtained polycarbonate copolymer can have the structural units represented by the general formulas (1) to (3) in a mole ratio within the above described range.

In the case of interfacial polymerization, the molecular weight of the polycarbonate copolymer can be controlled in the following manner. The molecular weight change of the polycarbonate copolymer is tracked during polymerization by a technique such as chromatography, and when the molecular weight reaches a desired value, an end stopper is added to a reaction system as a molecular weight controlling agent to adjust the molecular weight of the polycarbonate copolymer to a desired value. As the end stopper, one usually used in this field can be used. Examples of such an end stopper include monovalent aromatic hydroxy compounds, haloformate derivatives of monovalent aromatic hydroxy compounds, monovalent carboxylic acids, and halide derivatives of monovalent carboxylic acids. Among them, monovalent aromatic hydroxy compounds are preferably used, and phenol, p-tert-butylphenol, and p-cumylphenol are more preferably used. In a case where such an end stopper is used, an obtained polycarbonate copolymer usually has an end stopper-derived monovalent substituent bonded to its C-terminal and O-terminal.

Further, in the case of interfacial polymerization, polycarbonate copolymer molecules having a narrow molecular weight distribution can be obtained in a short period of time by emulsifying a reaction medium by high-speed stirring or addition of an emulsifier during polymerization reaction.

The interfacial polymerization is performed at a temperature of, for example, 0 to 40° C. within about several minutes to 5 hours. It is preferred that the pH of the aqueous phase is usually kept at 10 or higher by, for example, addition of a base.

(Solution Polymerization)

A monomer composed of a dihydroxy compound corresponding to the general formula (1), a monomer composed of a dihydroxy compound corresponding to the general formula (2), and a monomer composed of a trihydroxy compound are polymerized in an appropriate solvent in the presence of a deoxidizer to produce a polycarbonate copolymer.

More specifically, the dihydroxy compounds and the trihydroxy compound are dissolved in a solvent to obtain a solution, and a deoxidizer is optionally added to the solution. Then, a carbonate compound such as bischloroformate, phosgene, phosgene dimer, phosgene trimer, or phosgene polymer is further added to the solution to perform polymerization reaction to obtain a polycarbonate copolymer.

It is to be noted that the ratio by amounts of the dihydroxy compound corresponding to the general formula (1), the dihydroxy compound corresponding to the general formula (2), and the trihydroxy compound used is not particularly limited, but is preferably set so that an obtained polycarbonate copolymer can have, the structural units represented by the general formulas (1) to (3) in a mole ratio within the above described range.

As the solvent, one usually used in this field can be used as long as it is inactive against polymerization reaction and can dissolve or disperse the three kinds of monomers and the deoxidizer therein. Examples of such a solvent include: halogenated hydrocarbons such as dichloromethane, -dichloroethane, trichloroethane, tetrachloroethane, trichloroethylene, and chloroform; cyclic ethers such as tetrahydrofuran and dioxane; and pyridine. As the deoxidizer, one usually used in this field can be used. Examples of such a deoxidizer include: tertiary amines such as trimethylamine, triethylamine, and tripropylamine; and pyridine.

Further, as in the case of interfacial polymerization, a molecular weight controlling agent can be added to a reaction system.

The solution polymerization is usually performed at a temperature of 0 to 40° C. within about several minutes to 5 hours.

(Transesterification)

A carbonate compound, a dihydroxy compound corresponding to the general formula (1), a dihydroxy compound corresponding to the general formula (2), and a trihydroxy compound are mixed in an atmosphere of, for example, an inert gas, and the mixture is usually subjected to reaction at 120 to 350° C. under a reduced pressure to obtain a polycarbonate copolymer. It is preferred that the degree of reduced pressure is changed stepwise and is finally brought to 1 mmHg or less to remove phenols produced as by-products from a reaction system by distillation. The time required for reaction is usually about 1 to 4 hours. If necessary, a molecular weight controlling agent, an antioxidant, etc. may be added to the reaction system.

Further, by appropriately selecting operation for polymerization in each of the polymerization methods described above, it is possible to selectively produce a random copolymer, alternating copolymer, block copolymer, random alternating copolymer, or random block copolymer.

For example, in a case where a dihydroxy compound corresponding to the general formula (1), a dihydroxy compound corresponding to the general formula (2), and a trihydroxy compound are uniformly mixed and the resulting mixture is subjected to condensation reaction with a carbonate compound, a random copolymer is obtained.

The thus obtained polycarbonate copolymer can be easily separated and purified by purification techniques generally used, such as extraction, chromatography, centrifugation, recrystallization, and washing from the reaction mixture after polymerization reaction.

If necessary, one or more additives generally used for resins, selected from antioxidants, photostabilizers, heat stabilizers, lubricants, plasticizers and so on can be added to the polycarbonate copolymer.

(Electrophotographic Photoreceptor)

The structure of the electrophotographic photoreceptor of the present invention is not particularly limited as long as it has a surface layer containing the polycarbonate copolymer described above.

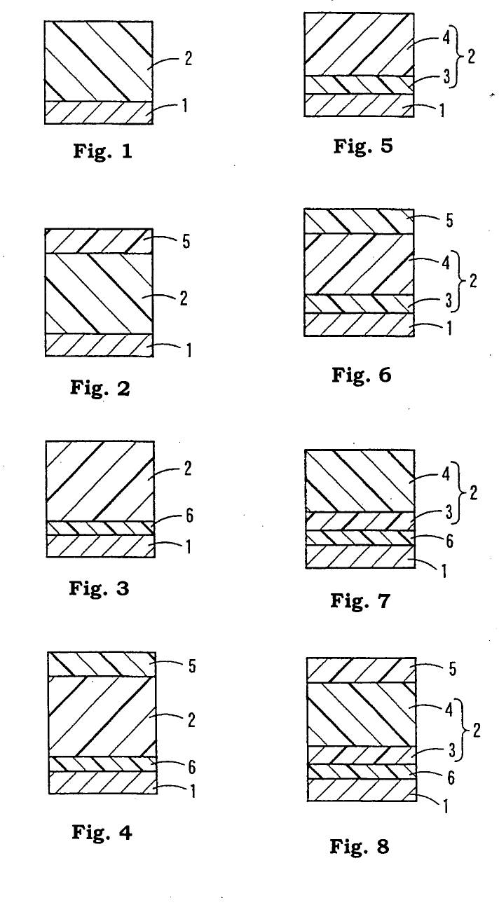

FIGS. 1 to 8 are cross-sectional views which schematically show the structure of main parts of the electrophotographic photoreceptor. The electrophotographic photoreceptors shown in FIGS. 1 to 4 are single layer-type electrophotographic photoreceptors characterized by having a photosensitive layer 2 composed of a single layer. On the other hand, the electrophotographic photoreceptors shown in FIGS. 5 to 8 are function separation- or multi-layered type electrophotographic photoreceptors characterized by having a photosensitive layer 2 composed of a charge generation layer 3 and a charge transport layer 4.

The electrophotographic photoreceptor shown in FIG. 1 includes a conductive support (original tube for electrophotographic photoreceptor) 1 and a photosensitive layer 2 formed on the surface of the conductive support 1.

The electrophotographic photoreceptor shown in FIG. 2 includes a conductive support 1, a photosensitive layer 2 formed on the surface of the conductive support 1, and a surface protective layer 5 formed on the surface of the-photosensitive layer 2.

The electrophotographic photoreceptor shown in FIG. 3 includes a conductive support 1, an undercoat layer 6 formed on the surface of the conductive support 1, and a photosensitive layer 2 formed on the surface of the undercoat layer 6.

The electrophotographic photoreceptor shown in FIG. 4 includes a conductive support 1, an undercoat layer 6 formed on the surface of the conductive support 1, a photosensitive layer 2 formed on the surface of the undercoat layer 6, and a surface protective layer 5 formed on the surface of the photosensitive layer 2.

The electrophotographic photoreceptor shown in FIG. 5 includes a conductive support 1, a charge generation layer 3 formed on the surface of the conductive support 1, and a charge transport layer 4 formed on the surface of the charge generation layer 3.

The electrophotographic photoreceptor shown in FIG. 6 includes a conductive support 1, a charge generation layer 3 formed on the surface of the conductive support 1, a charge transport layer 4 formed on the surface of the charge generation layer 3, and a surface protective layer 5 formed on the surface of the charge transport layer 4.

The electrophotographic photoreceptor shown in FIG. 7 includes a conductive support 1, an undercoat layer 6 formed on the surface of the conductive support 1, a charge generation layer 3 formed on the surface of the undercoat layer 6, and a charge transport layer 4 formed on the surface of the charge generation layer 3.

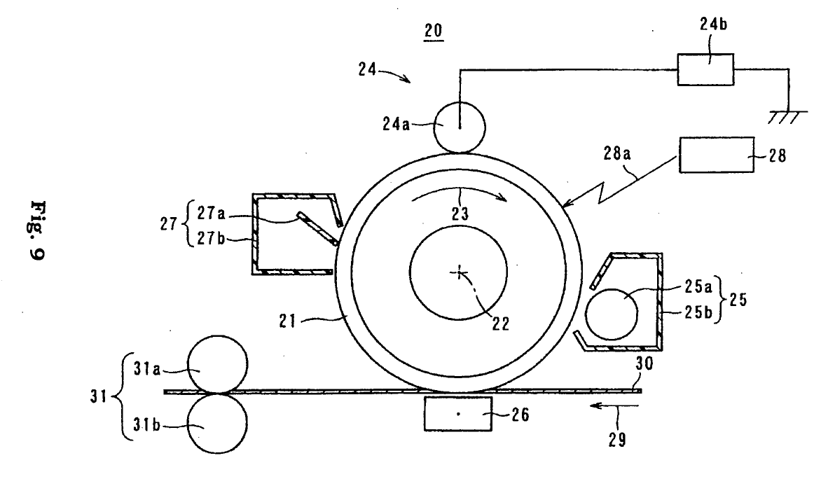

The electrophotographic photoreceptor shown in FIG. 8 includes a conductive support 1, an undercoat layer 6 formed on the surface of the conductive support 1, a charge generation layer 3 formed on the surface of the undercoat layer 6, a charge transport layer 4 formed on the surface of the charge generation layer 3, and a surface protective layer 5 formed on the surface of the charge transport layer 4.

It is to be noted that, in these electrophotographic photoreceptors shown in FIGS. 1 to 8, when a surface protective layer 5 is included in the electrophotographic photoreceptor, the entire or a part of the surface protective layer 5 provides the surface layer of the electrophotographic photoreceptor, and when a surface protective layer 5 is not included in the electrophotographic photoreceptor, the entire or a part of the photosensitive layer 2 provides the surface layer of the electrophotographic photoreceptor. However, in the former case, the photosensitive layer 2 provided under the surface protective layer 5 may also contain the polycarbonate copolymer having the structural units described above.

Hereinbelow, each of the layers constituting the electrophotographic photoreceptors shown in FIGS. 1 to 8 will be more specifically described.

(Conductive Support)

The conductive support 1 can be made of a metal material such as aluminum, aluminum alloys, copper, zinc, stainless steel, or titanium. However, a material for forming the conductive support 1 is not limited to these metal materials. For example, the conductive support 1 may also be formed using a material obtained by laminating a metal foil, or evaporating a metal material, or evaporating or applying a layer composed of a conductive compound (e.g., conductive polymer, tin oxide, indium oxide, carbon particles, metal particles) onto the surface of a substrate made of a synthetic resin (e.g., polyethylene terephthalate, polyester, polyoxymethylene, polystyrene), hard paper, or glass.

If necessary, the surface of the conductive support 1 may be subjected to anodizing treatment, surface treatment with chemicals or hot water, coloring treatment, or diffuse reflection treatment (e.g., surface roughening) as long as image quality is not adversely affected. The diffuse reflection treatment is particularly effective in a case where the electrophotographic photoreceptor is used in an electrophotographic process using laser light as an exposure light source. More specifically, in an electrophotographic process using laser as an exposure light source, since laser light has a single wavelength, there is a case where interference occurs between incident laser light and light reflected inside the electrophotographic photoreceptor, and therefore interference fringes caused by the interference appear on an image to form an image defect. However, by subjecting the surface of the conductive support to diffuse reflection treatment, it is possible to prevent such an image defect caused by interference of laser light having a single wavelength.

(Photosensitive Layer)

The photosensitive layer 2 shown in FIGS. 1 to 4 contains a charge generation material, a charge transport material, and the polycarbonate copolymer. The polycarbonate copolymer contained in the photosensitive layer 2 functions as a binder resin. If necessary, the photosensitive layer 2 may further contain another binder resin other than the polycarbonate copolymer having the structural units described above, an antioxidant, etc. The polycarbonate copolymer may be one kind or a mixture of two or more kinds of them. The amount of the polycarbonate copolymer, having the structural units described above, contained in the photosensitive layer 2 is preferably in the range of 50 to 75% by weight.

The charge generation material absorbs light to generate charges. As such a charge generation material, one usually used in this field can be used, and examples thereof include: organic pigments such as azo-based pigments (e.g., monoazo-based pigments, bisazo-based pigments, trisazo-based pigments), indigo-based pigments (e.g., indigo, thioindigo), perylene-based pigments (e.g., peryleneimide, perylene acid anhydrides), polycyclic quinone-based pigments (e.g., anthraquinone, pyrenequinone), phthalocyanine-based pigments (e.g., metal phthalocyanine, metal-free phthalocyanine), triphenylmethane-based pigments (e.g., methyl violet, crystal violet, night blue, Victoria blue), acridine-based pigments (e.g., erythrosine, rhodamine B, rhodamine 3R, acridine orange, flapeosine), thiazine-based pigments (e.g., methylene blue, methylene green), oxadine-based pigments (e.g., Capri blue, Merdla blue), squarylium pigments, pyrylium salts, thiopyrylium salts, thioindigo-based pigments, bisbenzoimidazole-based pigments, quinacridon-based pigments, quinoline-based pigments, lake-based pigments, azolake-based pigments, dioxazine-based pigments, azulenium-based pigments, triarylmethane-based pigments, xanthene-based pigments and cyanine-based pigments; dyes; and inorganic materials such as amorphous silicon, amorphous selenium, tellurium, selenium-tellurium alloy, cadmium sulfide, antimony sulfide, zinc oxide, and zinc sulfide. These charge generation materials can be used singly or in combination of two or more of them.

The photosensitive layer 2 may contain a hole transport material and an electron transport material. As the hole transport material, one usually used in this field can be used, and examples thereof include carbazole derivatives, pyrene derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives, enamine derivatives, benzidine derivatives, polymers having a group derived from any one of these compounds in the main chain or side chain thereof (e.g., poly-N-vinylcarbazole, poly-1-vinylpyrene, ethylcarbazole-formaldehyde resin, triphenylmethane polymer, poly-9-vinylanthracene), and polysilane.

As the electron transport material, one usually used in this field can be used, and examples thereof include: organic compounds such as benzoquinone derivatives, tetracyanoethylene derivatives, tetracyanoquinodimethane derivatives, fluorenone derivatives, xanthone derivatives, phenanthraquinone derivatives, phthalic anhydride derivatives, and diphenoquinone derivatives; inorganic materials such as amorphous silicon, amorphous selenium, tellurium, selenium-tellurium alloy, cadmium sulfide, antimony sulfide, zinc oxide, and zinc sulfide. These electron transport materials can be used singly or in combination of two or more of them.

Another binder resin is used to further improve the mechanical strength or durability of the photosensitive layer 2. As such another binder resin, one having high compatibility with the polycarbonate copolymer having the structural units described above is preferably used. Specific examples of such a binder resin include: thermoplastic resins such as polymethylmethacrylate, polystyrene, vinyl-based resins such as polyvinyl chloride, polycarbonate, polyester, polyestercarbonate, polysulfone, polyarylate, polyamide, methacrylic resins, acrylic resins, polyether, polyacrylamide, and polyphenylene oxide; thermosetting resins such as phenoxy resins, epoxy resins, silicone resins, polyurethane, and phenol resins; and partially crosslinked products thereof. Among them, polystyrene, polycarbonate, polyarylate, and polyphenylene oxide are preferably used as a binder resin because they have a volume resistivity value of 10¹³ Ω or higher and therefore provide excellent electrical insulation, and they also have excellent film formability and potential characteristics. Among them, polycarbonate is particularly preferably used. These other binder resins can be used singly or in combination of two or more of them.

The antioxidant can reduce deterioration of the surface layer caused by adhesion of an active material, such as ozone or NOₓ generated during the charging of the electrophotographic photoreceptor, thereto to improve the durability of the electrophotographic photoreceptor to withstand repeated use. The antioxidant also improves the stability of a coating liquid for forming photosensitive layer (which will be described later), which prolongs the life of the coating liquid. In addition, by using such a coating liquid to produce an electrophotographic photoreceptor, it is possible to reduce impurities and therefore to improve the durability of the electrophotographic photoreceptor.

Examples of such an antioxidant include hindered phenol derivatives and hindered amine derivatives. The amount of the antioxidant to be used is not particularly limited, but is preferably in the range of 0.1 to 10 parts by weight with respect to 100 parts by weight of the charge transport material. If the amount of the antioxidant to be used is less than 0.1 part by weight, the effect of improving the stability of a coating liquid for forming photosensitive layer (which will be described later) and the durability of the electrophotographic photoreceptor cannot be sufficiently obtained. On the other hand, if the amount of the antioxidant to be used exceeds 10 parts by weight, there is a case where the electric characteristics of the electrophotographic photoreceptor are adversely affected.

The photosensitive layer 2 can be formed by preparing a coating liquid for forming photosensitive layer by dissolving and/or dispersing the charge generation material, the polycarbonate copolymer having the structural units described above, the charge transport material, and if necessary another binder resin, the antioxidant, etc. in an appropriate organic solvent, applying the coating liquid onto the surface of the conductive support 1 or the undercoat layer 6 (which will be described later), and drying the applied coating liquid to remove the organic solvent.

Examples of the organic solvent to be used for preparing the coating liquid include: aromatic hydrocarbons such as benzene, toluene, xylene, mesitylene, tetralin, diphenylmethane, dimethoxybenzene, and dichlrolobenzene; halogenated hydrocarbons such as dichloromethane and dichloroethane; ethers such as tetrahydrofuran (THF), dioxane, dibenzyl ether, and dimethoxymethyl ether; ketones such as cyclohexanone, acetophenone, and isophorone; esters such as methyl benzoate and ethyl acetate; sulfur-containing compounds such as diphenyl sulfide; fluorine-based compounds such as hexafluoroisopropanol; aprotic polar compounds such as N,N-dimethylformamide; mixtures of two or more of these solvents; and mixtures of one or more of these compounds and alcohol, acetonitrile, or methyl ethyl ketone.

The thickness of the photosensitive layer is not particularly limited, but is preferably in the range of 5 to 100 μm, more preferably in the range of 10 to 50 μm. If the thickness of the photosensitive layer is less than 5 μm, there is a case that the charge retention ability of the surface of the electrophotographic photoreceptor is lowered. On the other hand, if the thickness of the photosensitive layer exceeds 100 μm, there is a case that the productivity of the electrophotographic photoreceptor is lowered.

(Charge Generation Layer and Charge Transport Layer)

The photosensitive layer 2 shown in FIGS. 5 to 8 is composed of a charge generation layer 3 and a charge transport layer 4 which are laminated together.

The charge generation layer 3 contains a charge generation material and a binder resin.

Examples of the charge generation material include the same charge generation materials as mentioned above with reference to the photosensitive layer 2. These charge generation materials can be used singly or in combination of two or more of them.

As the binder resin, one usually used as a matrix resin of a charge generation layer can be used, and examples thereof include: thermoplastic resins such as polyester, polystyrene, acrylic resins, methacrylic resins, polycarbonate (including the polycarbonate copolymer having the structural units described above), and polyarylate; thermosetting resins such as polyurethane, phenol resins, alkyd resins, melamine resins, epoxy resins, silicone resins, phenoxy resins, polyvinyl butyral, and polyvinylformal; copolymer resins containing two or more structural units contained in these resins (insulating resins such as vinyl chloride-vinyl acetate copolymer resin, vinyl chloride-vinyl acetate-maleic anhydride copolymer resin, acrylonitrile-styrene copolymer resin). Among them, polyvinyl butyral is preferably used. These binder resins can be used singly or in combination of two or more of them.

The weight ratio between the charge generation material and the binder resin contained in the charge generation layer 3 is not particularly limited, but the amount of the charge generation material contained in the charge generation layer 3 is preferably 10 to 99% by weight when the total amount of the charge generation material and the binder resin is defined as the entire weight of the charge generation layer 3. If the amount of the charge generation material is less than 10% by weight, there is a case that sensitivity is lowered. On the other hand, if the amount of the charge generation material exceeds 99% by weight, there are cases where (1) the film strength of the charge generation layer 3 is lowered and (2) the dispersibility of the charge generation material is lowered and therefore the number of coarse particles is increased so that surface charges in a portion other than a portion where charges are to be removed by exposure are reduced. Such a reduction in film strength and surface charge becomes a cause of generation of many image defects, especially, image fog called black spots which are fine black dots of toner adhered to a white background.

In addition to the two essential components described above, if necessary, the charge generation layer 3 may further contain an appropriate amount of one or more additives selected from hole transport materials, electron transport materials, antioxidants, dispersion stabilizers, sensitizers and so on. By adding such one or more additives, it is possible to improve potential characteristics, and to enhance the stability of a coating liquid for forming charge generation layer (which will be described later), and to reduce the fatigue deterioration of the electrophotographic photoreceptor caused by repeated use, thereby improving the durability of the electrophotographic photoreceptor.

The charge generation layer 3 can be formed by, for example, preparing a coating liquid for forming charge generation layer by dissolving or dispersing the charge generation material, the binder resin, and if necessary, one or more additives in an appropriate organic solvent, applying the coating liquid onto the surface of the conductive support 1 or the undercoat layer 6 (which will be described later), and drying the applied coating liquid to remove the organic solvent. More specifically, the coating liquid for forming charge generation layer is prepared by, for example, dissolving the binder resin in an organic solvent to obtain a resin solution, and dissolving or dispersing the charge generation material and, if necessary, one or more additives in the resin solution.

Examples of the organic solvent to be used for preparing the coating liquid for forming charge generation layer include: halogenated hydrocarbons such as tetrachloropropane and dichloroethane; ketones such as isophorone, methyl ethyl ketone, acetophenone, and cyclohexanone; esters such as ethyl acetate, methyl benzoate, and butyl acetate; ethers such as tetrahydrofurane (THF), dioxane, dibenzyl ether, 1,2-dimethoxyethane, and dioxane; aromatic hydrocarbons such as benzene, toluene, xylene, mesitylene, tetralin, diphenylmethane, dimethoxybenzene, and dichlorobenzene; sulfur-containing compounds such as diphenyl sulfide; fluorine-based compounds such as hexafluoroisopropanol; and aprotic polar compounds such as N,N-dimethylformamide and N,N-dimethylacetoamide. A mixed solvent obtained by mixing two or more of these compounds can also be used.

Prior to dissolving or dispersing the charge generation material and, if necessary, one or more additives in the resin solution, they may be previously pulverized. Examples of a pulverizer to be used for previously pulverizing the charge generation material etc. include pulverizers generally used, such as a ball mill, a sand mill, an atoliter, a vibration mill, and an ultrasonic dispersing device.

The charge generation material and, if necessary, one or more additives are dissolved or dispersed in the resin solution by using a dispersing device generally used, such as a paint shaker, a ball mill, or a sand mill. At this time, it is preferred that dispersion conditions are appropriately selected so that impurities are not generated by abrasion of the structural components of the dispersing device and a container used for holding the resin solution, the charge generation material and so on to prevent contamination of the coating liquid with the impurities.

Examples of a method for applying the coating liquid for forming charge generation layer include roll coating, spray coating, blade coating, ring coating, and dip coating.

The thickness of the charge generation layer 3 is not particularly limited, but is preferably in the range of 0.05 to 5 μm, more preferably in the range of 0.1 to 1 μm. If the thickness of the charge generation layer is less than 0.05 μm, there is a case where the efficiency of light absorption is lowered so that sensitivity is lowered. On the other hand, if the thickness of the charge generation layer exceeds 5 μm, there is a case where charge transfer in the inside of the charge generation layer becomes the rate-determining step in the process of erasing charges on the surface of the electrophotographic photoreceptor so that sensitivity is lowered.

The charge transport layer 4 can be formed using the polycarbonate copolymer having the structural units described above, which has the ability to receive and transport charges generated in the charge generation material. The charge transport layer 4 may further contain a charge transport material, another binder resin, an antioxidant, etc. It is preferred that the charge transport layer 4 contains a charge transport material as an essential component. The polycarbonate copolymer having the structural units described above may be one kind or a mixture of two or more kinds of them. The charge transport layer 4 preferably contains the polycarbonate copolymer having the structural units described above in an amount of 50 to 75% by weight.

Examples of another binder resin and the antioxidant can include the same binder resins and antioxidants as mentioned above with reference to the photosensitive layer 2. The amount of another binder resin to be used for forming the charge transport layer 4 can be the same as that used for forming the photosensitive layer 2. The amount of the antioxidant to be used for forming the charge transport layer 4 can be the same as that used for forming the photosensitive layer 2.

The charge transport layer 4 can be formed by, for example, preparing a coating liquid for forming charge transport layer by dissolving or dispersing the polycarbonate copolymer having the structural units described above and, if necessary, the charge transport material, another binder resin, the antioxidant, etc. in an appropriate organic solvent, applying the coating liquid for forming charge transport layer onto the surface of the charge generation layer 3, and drying the applied coating liquid to remove the organic solvent.

Examples of the organic solvent to be used for preparing the coating liquid for forming charge transport layer can include the same organic solvents as mentioned above with reference to the photosensitive layer 2. A method for applying the coating liquid for forming charge transport layer onto the surface of the charge generation layer 3 is not particularly limited, and examples thereof include dip coating, roll coating, and ink-jet coating. The temperature for drying the applied coating liquid is appropriately selected so that the organic solvent contained in the coating liquid can be removed and that the charge transport layer 4 can have a uniform surface.

The thickness of the charge transport layer 4 is not particularly limited, but is preferably in the range of 5 to 50 μm, more preferably in the range of 10 to 40 μm. If the thickness of the charge transport layer is less than 5 μm, there is a case that the charge retention ability of the surface of the electrophotographic photoreceptor is lowered. On the other hand, if the thickness of the charge transport layer exceeds 50 μm, there is a case that the resolution of the electrophotographic photoreceptor is lowered.

(Surface Protective Layer)

The surface protective layer 5 has the function of improving the durability of, for example, the photosensitive layer 2. The surface protective layer 5 can be formed by, for example, applying a resin solution, prepared by dissolving a binder resin in an appropriate organic solvent, onto the surface of the photosensitive layer 2 and drying the applied resin solution to remove the organic solvent. Examples of a binder resin, a charge transport material, and an organic solvent to be used for forming a surface protective layer can include the same binder resins, charge transport materials, and organic solvents as mentioned above with reference to the charge transport layer 4. However, the amount of the charge transport material contained in the surface protective layer 5 is preferably smaller than that contained in the charge transport layer 4 from the viewpoint of improving the wear resistance of the surface protective layer 5. The surface protective layer 5 preferably contains the polycarbonate copolymer having the structural units described above as a binder resin. The amount of the polycarbonate copolymer, having the structural units described above, contained in the surface protective layer 5 is preferably in the range of 70 to 90% by weight.

The thickness of the surface protective layer 5 is not particularly limited, but is preferably in the range of 0.5 to 10 μm, more preferably in the range of 1 to 5 μm. If the thickness of the surface protective layer 5 is less than 0.5 μm, there is a case where the surface of the electrophotographic photoreceptor is poor in resistance to scratching so that the electrophotographic photoreceptor does not have sufficient durability. On the other hand, if the thickness of the surface protective layer 5 exceeds 10 μm, the resolution of the electrophotographic photoreceptor is lowered.

(Undercoat Layer)

The undercoat layer 6 has the function of preventing injection of charges from the conductive support 1 to the photosensitive layer 2. By providing such an undercoat layer 6, it is possible to suppress the deterioration of charging characteristics of the photosensitive layer 2 and therefore to suppress reduction in surface charges in a portion other than a portion where charges are to be erased by exposure, thereby preventing the occurrence of image defects such as fog. Particularly, it is possible to prevent the occurrence of image fog called black spots which are fine black dots of toner appearing in a white background during image formation in a reverse development process. In addition, by coating the surface of the conductive support 1 with the undercoat layer 6, it is also possible to reduce surface defects, such as surface irregularities, of the conductive support 1 to obtain a smooth surface. Therefore, by forming the photosensitive layer 2 on the undercoat layer 6, it is possible to improve the film formability of the photosensitive layer 2, thereby enabling the photosensitive layer 2 to be more firmly adhered to the conductive support 1.

The undercoat layer 6 can be formed by, for example, preparing a coating liquid for forming undercoat layer by dissolving a resin material in an appropriate solvent, applying the coating liquid onto the surface of the conductive support 1, and applying heat to the applied coating liquid to remove the solvent contained therein. Examples of the resin material for forming a resin layer include: thermoplastic resins such as polyethylene, polypropylene, polystyrene, acrylic resins, vinyl chloride resins, vinyl acetate resins, polyester, polycarbonate, polyestercarbonate, polysulfone, polyvinyl butyral, polyamide, and polyarylate; thermosetting resins such as polyurethane, epoxy resins, melamine resins, phenoxy resins, and silicone resins; copolymer resins containing two or more structural units contained in these thermoplastic resins or thermosetting resins; and naturally-occurring polymers such as casein, gelatin, polyvinyl alcohol, and ethyl cellulose. Examples of the solvent to be used for dissolving or dispersing the resin material include: water; alcohols such as methanol, ethanol, and butanol; glymes such as methyl carbitol and butyl carbitol; and mixtures of two or more of these solvents.

The coating liquid for forming undercoat layer may further contain metal oxide particles. By adding metal oxide particles to the coating liquid, it is possible to easily control the volume resistance value of the undercoat layer 6, and to further suppress injection of charges from the conductive support 1 into the photosensitive layer 2 and to maintain electric characteristics of the electrophotographic photoreceptor in various environments. Examples of the metal oxide particles include titanium oxide particles, aluminum oxide particles, aluminum hydroxide particles, and tin oxide particles. Examples of a device to be used for dispersing such metal oxide particles in the coating liquid for forming undercoat layer include devices generally used for dispersing particles, such as a ball mill, a sand mill, an atoliter, a vibration mill, and an ultrasonic dispersing device.

When the total amount of the resin material and the metal oxide particles contained in the coating liquid for forming undercoat layer is defined as C, and the amount of the solvent contained in the coating liquid for forming undercoat layer is defined as D, the weight ratio between C and D (C/D) is preferably in the range of 1/99 to 40/60 (=0.01 to 0.67), more preferably in the range of 2/98 to 30/70 (=0.02 to 0.43). Further, when the amount of the resin material contained in the coating liquid for forming undercoat layer is defined as E, and the amount of the metal oxide particles contained in the coating liquid for forming undercoat layer is defined as F, the weight ratio between E and F (E/F) is preferably in the range of 1/99 to 90/10 (=0.01 to 9.0), more preferably in the range of 5/95 to 70/30 (=0.05 to 2.33).

The thickness of the undercoat layer 6 is not particularly limited, but is preferably in the range of 0.01 to 20 μm, more preferably in the range of 0.1 to 10 μm. If the thickness of the undercoat layer 6 is less than 0.01 μm, there is a case where it is virtually impossible for the undercoat layer 6 to play a role as an undercoat layer, that is, the undercoat layer 6 cannot provide a uniform surface to cover the surface defects of the conductive support 1, and cannot prevent injection of charges from the conductive support 1 into the photosensitive layer 2, thereby deteriorating the charging characteristics of the photosensitive layer 2. On the other hand, if the thickness of the undercoat layer 6 exceeds 20 μm, there is a case where it is difficult to form a uniform undercoat layer or the sensitivity of the electrophotographic photoreceptor is lowered.

Alternatively, the undercoat layer 6 may be provided as a surface layer of the conductive support 1 containing anodized aluminum (i.e., as an anodized aluminum layer).

(Image-Forming Apparatus)

FIG. 9 is a cross-sectional view of an image-forming apparatus 20 of the present invention, which simply shows the arrangement of components of the image-forming apparatus 20. The image-forming apparatus 20 includes an electrophotographic photoreceptor 21 having any one of the structures shown in FIGS. 1 to 8. Referring to FIG. 9, the image-forming apparatus 20 will be described below. It is to be noted that the image-forming apparatus of the present invention is not limited by the following description.

The image-forming apparatus 20 includes an electrophotographic photoreceptor 21 rotatably supported by a main body (not shown) of the apparatus, a charger 24, exposure part 28, a developing device 25, a transferring device 26, a cleaner 27, and a fixing device 31.

The electrophotographic photoreceptor 21 is rotated by driving part (not shown) around a rotation axis 22 in a direction shown by an arrow 23. The driving part includes, for example, an electric motor and a reduction gear, and its driving force is transmitted to the conductive support constituting a core member of the electrophotographic photoreceptor 21 so that the electrophotographic photoreceptor 21 is rotated at a predetermined circumferential velocity. The charger 24, exposure part 28, developing device 25, transferring device 26, and cleaner 27 are provided around the outer circumferential surface of the electrophotographic photoreceptor 21 in this order from the upstream to the down stream of the rotation direction of the electrophotographic photoreceptor 21 shown by the arrow 23.

The charger 24 is charging part for charging the outer circumferential surface of the electrophotographic photoreceptor 21 at a predetermined potential. The charger 24 shown in FIG. 9 includes a contact-type charging roller 24a and a bias supply 24b for applying voltage to the charging roller 24a. As such charging part, a charger wire can also be used. Particularly, in the former case where a charging roller is used, the electrophotographic photoreceptor of the present invention having improved durability is suitably used because the surface of the photoreceptor is required to have high wear resistance.

The exposure part 28 is equipped with, for example, a semiconductor laser as a light source, and therefore can irradiate the surface of the electrophotographic photoreceptor 21 positioned between the charger 24 and the developing device 25 with light 28a such as laser beams emitted from the light source to expose the outer circumferential surface of the charged electrophotographic photoreceptor 21 to light in accordance with image information. The light 28a usually repeatedly scans the electrophotographic photoreceptor 21 in a direction along the rotation axis 22, which is a main scanning direction, to form electrostatic latent images sequentially on the surface of the electrophotographic photoreceptor 21.

The developing device 25 is developing part for developing the electrostatic latent images formed by exposure on the surface of the electrophotographic photoreceptor 21 with a developer. The developing device 25 includes a developing roller 25a and a casing 25b. The developing roller 25a is provided so as to be opposed to the electrophotographic photoreceptor 21 to supply toner to the outer circumferential surface of the electrophotographic photoreceptor 21. The casing 25b supports the developing roller 25a so that the developing roller 25a can rotate around a rotation axis parallel to the rotation axis 22 of the electrophotographic photoreceptor 21, and holds the developer containing toner in the internal space thereof.

The transferring device 26 is transferring part for transferring toner images, which are visible images formed on the outer circumferential surface of the electrophotographic photoreceptor 21 by development, onto a transfer paper 30 which is a recording medium fed between the electrophotographic photoreceptor 21 and the transferring device 26 along a direction shown by an arrow 29 by conveying part (not shown). The transferring device 26 is, for example, noncontact transferring part equipped with charging part to allow the transfer paper 30 to be charged to a polarity opposite to that of the toner to thereby transfer the toner images onto the transfer paper 30.

The cleaner 27 is cleaning part for removing and collecting the toner remaining on the outer circumferential surface of the electrophotographic photoreceptor 21 after transfer operation performed by the transferring device 26. The cleaner 27 includes a cleaning blade 27a for scraping the remaining toner off the outer circumferential surface of the electrophotographic photoreceptor 21 and a casing 27b for holding the toner collected by the cleaning blade 27a. The cleaner 27 may be provided with a discharge lamp (not shown).

The image-forming apparatus 20 may include a fixing device 31 that is fixing part for fixing the transferred images. The fixing device 31 is provided downstream of the transferring device 26 along a path where the transfer paper 30 passed between the electrophotographic photoreceptor 21 and the transferring device 26 is conveyed. The fixing device 31 includes a heating roller 31a equipped with heating part (not shown) and a pressure roller 31b provided so as to be opposed to the heating roller 31a and brought into pressure contact with the heating roller 31a.

An image-forming operation can be performed by the image-forming apparatus 20 in the following manner.

First, the electrophotographic photoreceptor 21 is rotated by the driving part in a direction shown by the arrow 23, and then the surface of the electrophotographic photoreceptor 21 is positively or negatively charged uniformly at a predetermined potential by the charger 24 provided upstream of the image point of the light 28a, emitted from the exposure part 28, in the rotation direction of the electrophotographic photoreceptor 21.

Then, the surface of the electrophotographic photoreceptor 21 is irradiated with the light 28a emitted from the exposure part 28 in accordance with image information. As a result of exposure, the surface charges of the electrophotographic photoreceptor 21 in a portion irradiated with the light 28a are erased, which causes difference between the surface potential of the portion irradiated with the light 28a and the surface potential of a portion not irradiated with the light 28a so that electrostatic latent images are formed on the surface of the electrophotographic photoreceptor 21.

Then, the developing device 25 provided downstream of the image point of the light 28a, emitted from the exposure part 28, in the rotation direction of the electrophotographic photoreceptor 21 supplies the surface of the electrophotographic photoreceptor 21, having electrostatic latent images formed thereon, with toner to develop the electrostatic latent images so that toner images are formed.

In synchronization with the exposure of the electrophotographic photoreceptor 21 to light, the transfer paper 30 is fed between the electrophotographic photoreceptor 21 and the transferring device 26. The transfer paper 30 is charged to a polarity opposite to that of the toner by the transferring device 26 to transfer the toner images formed on the surface of the electrophotographic photoreceptor 21 onto the transfer paper 30.

The transfer paper 30, onto which the toner images have been transferred, is conveyed to the fixing device 31 by conveying part, and is then heated and pressed when passing through the contact portion between the heating roller 31a and the pressure roller 31b so that the toner images are fixed to the transfer paper 30 to provide solid images. The transfer paper 30 having images formed thereon is discharged out of the image-forming apparatus 20 by the conveying part.

On the other hand, the toner remaining on the surface of the electrophotographic photoreceptor 21 even after the toner images are transferred onto the transfer paper 30 by the transferring device 26 is scraped off the surface of the electrophotographic photoreceptor 21 by the cleaner 27 and collected. The surface charges of the electrophotographic photoreceptor 21, from which the toner has been removed, are erased by light from a discharge lamp so that the electrostatic latent images on the surface of the electrophotographic photoreceptor 21 disappear. Thereafter, the electrophotographic photoreceptor 21 is further rotated to repeat a series of operations starting with charging so that images are continuously formed.

As described above, the image-forming apparatus of the present invention includes the electrophotographic photoreceptor having a surface layer which is appropriately conductive and has excellent durability, and therefore can form high-quality images in various environments.

### EXAMPLES

Hereinbelow, the present invention will be described more specifically with reference to examples and comparative examples. It is to be noted that, the term “part(s)” in the following description refers to “part(s) by weight”.

### Production Example 1

1.62 g of sodium hydroxide and 0.075 g of sodium hydrosulfite were dissolved in 60 mL of water to prepare a solution. To the solution, 0.09 g (0.44 mmol) of 4,4-bishydroxyphenyl ether as an ether structure component monomer (i.e., as a dihydroxy compound corresponding to the general formula (1)), 1.34 g (5.0 mmol) of 1,1-bis(4-hydroxyphenyl)cyclohexane as a cyclic alkyl structure component monomer (i.e., as a dihydroxy compound corresponding to the general formula (2)), and 0.014 g (0.11 mmol) of 1,3,5-trihydroxybenzene as a branched structure component monomer (i.e., as a trihydroxy compound corresponding to the general formula (3)), and 0.030 g of 4-tert-butylphenol were added, and the resulting mixture was stirred under a flow of argon. A solution obtained by dissolving 2.11 g of triphosgene in 40 mL of dichloromethane was dropped little by little into the mixture vigorously stirred and cooled in an ice bath (at about −5 to 0° C.) to react them for 1.5 hours to emulsify the mixture. After the completion of dropping, the temperature of the reaction mixture was returned to room temperature (about 25 to 30° C.), and 0.25 g of sodium hydroxide and then 0.45 mL of triethylamine were added to the reaction mixture to react them at 25 to 30° C. for 3 hours. After the completion of the reaction, 200 mL of dichloromethane was added to the reaction mixture to extract an organic layer. The organic layer was washed with 100 mL of a 3% aqueous sodium hydroxide solution and with 100 mL of a 2% aqueous hydrochloric acid solution and with 100 mL of ion-exchanged water, and was then reprecipitated in methanol to obtain 3.23 g of a polycarbonate copolymer as a compound No. 1.

The molecular weight of the polycarbonate copolymer was measured by gel permeation chromatography (“KF-800 series” manufactured by Showa Denko K.K.). As a result, the polystyrene-reduced number average molecular weight of the polycarbonate copolymer was 29,000, and the polystyrene-reduced weight average molecular weight was 71,000. The infrared absorption spectrum of the polycarbonate copolymer showed absorption resulting from stretching vibration of C═O of carbonate at 1775 cm⁻¹. Further, from the area ratio of signals obtained by ¹H-NMR, it was found that the polycarbonate copolymer contained structural units derived from the three monomers, that is, 1,1-bis(4-hydroxyphenyl)cyclohexane, 4,4-bishydroxyphenyl ether, and 1,3,5-trihydroxybenzene in a ratio of 0.90/0.08/0.02.

### Production Example 2

3.35 g of a polycarbonate copolymer was obtained as a compound No. 7 in the same manner as in Production Example 1 except that the 1.28 g (5.0 mmol) of 2,2-bis(3-methyl-4-hydroxyphenyl)propane was used as a linear alkyl structure component monomer instead of the cyclic alkyl structure component monomer.

The molecular weight of the polycarbonate copolymer was measured by gel permeation chromatography. As a result, the polystyrene-reduced number average molecular weight of the polycarbonate copolymer was 30,500, and the polystyrene-reduced weight average molecular weight was 74,200. The infrared absorption spectrum of the polycarbonate copolymer showed absorption resulting from stretching vibration of C═O of carbonate at 1775 cm⁻¹. Further, from the area ratio of signals obtained by ¹H-NMR, it was found that the polycarbonate copolymer contained structural units derived from the three monomers, that is, 2,2-bis(3-methyl-4-hydroxyphenyl)propane, 4,4-bishydroxyphenyl ether, and 1,3,5-trihydroxybenzene in a ratio of 0.90/0.08/0.02.

### Production Example 3

3.35 g of a polycarbonate copolymer was obtained as a compound No. 4 in the same manner as in Production Example 1 except that the 1.16 g (5.1 mmol) of 2,2-bis(4-hydroxyphenyl)propane was used as a linear alkyl structure component monomer instead of the cyclic alkyl structure component monomer, and that the amount of 4,4-bishydroxyphenyl ether used was changed from 0.09 g to 0.06 g (0.28 mmol).

The molecular weight of the polycarbonate copolymer was measured by gel permeation chromatography. As a result, the polystyrene-reduced number average molecular weight of the polycarbonate copolymer was 28,000, and the polystyrene-reduced weight average molecular weight was 68,000. The infrared absorption spectrum of the polycarbonate copolymer showed absorption resulting from stretching vibration of C═O of carbonate at 1775 cm⁻¹. Further, from the area ratio of signals obtained by ¹H-NMR, it was found that the polycarbonate copolymer contained structural units derived from the three monomers, that is 2,2-bis(4-hydroxyphenyl)propane, 4,4-bishydroxyphenyl ether, and 1,3,5-trihydroxybenzene in a ratio of 0.93/0.05/0.02.

### Comparative Production Example 1

2.74 g of a polycarbonate copolymer was obtained in the same manner as in Production Example 1 except that 4,4-bishydroxyphenyl ether as an ether structure component monomer was not used.

The molecular weight of the polycarbonate copolymer was measured by gel permeation chromatography. As a result, the polystyrene-reduced number average molecular weight of the polycarbonate copolymer was 26,000, and the polystyrene-reduced weight average molecular weight was 68,000. The infrared absorption spectrum of the polycarbonate copolymer showed absorption resulting from stretching vibration of C═O of carbonate at 1775 cm⁻¹. Further, from the area ratio of signals obtained by ¹H-NMR, it was found that the polycarbonate copolymer contained structural units derived from the two monomers, that is, 1,1-bis(4-hydroxyphenyl)cyclohexane and 1,3,5-trihydroxybenzene in a ratio of 0.97/0.03.

### Comparative Production Example 2

2.95 g of a polycarbonate copolymer was obtained in the same manner as in Production Example 1 except that 1,3,5-trihydroxybenzene as a branched structure component monomer was not used.

The molecular weight of the polycarbonate copolymer was measured by gel permeation chromatography. As a result, the polystyrene-reduced number average molecular weight of the polycarbonate copolymer was 28,000, and the polystyrene-reduced weight average molecular weight was 72,000. The infrared absorption spectrum of the polycarbonate copolymer showed absorption resulting from stretching vibration of C═O of carbonate at 1775 cm⁻¹. Further, from the area ratio of signals obtained by ¹H-NMR, it was found that the polycarbonate copolymer contained structural units derived from the two monomers, that is, 1,1-bis(4-hydroxyphenyl)cyclohexane and 4,4-bishydroxyphenyl ether in a ratio of 0.88/0.12.

### Example 1

7 parts of titanium oxide (manufactured by Ishihara Sangyo Co., Ltd. under the trade name of “TTO55A”) and 13 parts of copolymer nylon resin (manufactured by Toray Industries Inc. under the trade name of “CM8000”) were added to a mixed solvent of 159 parts of methyl alcohol and 106 parts of 1,3-dioxolane, and were then subjected to dispersion treatment using a paint shaker for 8 hours to prepare a coating liquid for forming undercoat layer. The coating liquid for forming undercoat layer was filled in a tank for coating, and then a drum-shaped support made of aluminum (conductive support) having a diameter of 30 mm and a length of 340 mm was immersed in the tank for coating, pulled out of the tank for coating, and naturally dried to form an undercoat layer having a thickness of 1 μm.

Then, 1 part of titanylphthalocyanine having a CuKα 1.541 Å X-ray diffraction spectrum, in which a major peak is observed at a Bragg angle (2θ±0.2°) of 27.30, and 1 part of butyral resin (manufactured by Denki Kagaku Kogyo K.K. under the trade name of “#6000-C”) were mixed with 98 parts of methyl ethyl ketone, and the resulting mixture was subjected to dispersion treatment using a paint shaker to prepare a coating liquid for forming charge generation layer. The coating liquid for forming charge generation layer was applied onto the surface of the undercoat layer in the same manner as in the case of the formation of the undercoat layer, and was naturally dried to form a charge generation layer having a thickness of 0.4 μm.

Then, 100 parts of a butadiene compound (21) (1,1-bis(p-diethylaminophenyl)-4,4-diphenyl-1,3-butadiene, manufactured by Takasago Chemical Corporation under the trade name of “T405”) shown below, 100 parts of the polycarbonate copolymer (Compound No. 1) synthesized in Production Example 1, and 5 parts of 2,6-bis-tert-butyl-4-methylphenol (manufactured by Sumitomo Chemical Co., Ltd. under the trade name of “Sumilizer BHT”) were mixed with tetrahydrofuran as a solvent to prepare a coating liquid for forming charge transport layer having a solid content of 21% by weight. The coating liquid for forming charge transport layer was applied onto the surface of the charge generation layer in the same manner as in the case of the formation of the undercoat layer, and was dried at 110° C. for 1 hour to form a charge transport layer having a thickness of 21 μm. In this way, a multi-layered type electrophotographic photoreceptor having a structure shown in FIG. 7 was produced.

### Example 2

A multi-layered type electrophotographic photoreceptor was produced in the same manner as in Examples 1 except that the polycarbonate copolymer synthesized in Production Example 1 was replaced with the polycarbonate copolymer (compound No. 7) synthesized in Production Example 2.

### Example 3

A multi-layered type electrophotographic photoreceptor was produced in the same manner as in Examples 1 except that the polycarbonate copolymer synthesized in Production Example 1 was replaced with the polycarbonate copolymer (compound No. 4) synthesized in Production Example 3.

### Example 4

A 1 μm thick undercoat layer and a 0.4 μm thick charge generation layer were formed in this order on the surface of a drum-shaped support made of aluminum (conductive support) having a diameter of 30 mm and a length of 340 mm in the same manner as in Example 1.

Then, 100 parts of a butadiene compound (21) (1,1-bis(p-diethylaminophenyl)-4,4-diphenyl-1,3-butadiene, manufactured by Takasago Chemical Corporation under the trade name of “T405”) shown below, 100 parts of z-type polycarbonate having a structural unit (22) shown below (manufactured by Mitsubishi Gas Chemical Company, Inc. under the trade name of “Iupilon Z400”), and 5 parts of 2,6-bis-tert-butyl-4-methylphenol (manufactured by Sumitomo Chemical Co., Ltd. under the trade name of “Sumilizer BHT”) were mixed with tetrahydrofuran as a solvent to prepare a coating liquid for forming charge transport layer having a solid content of 21% by weight. The coating liquid for forming charge transport layer was applied onto the surface of the charge generation layer in the same manner as in the case of the formation of the undercoat layer, and was dried at 110° C. for 1 hour to form a charge transport layer having a thickness of 21 μm.

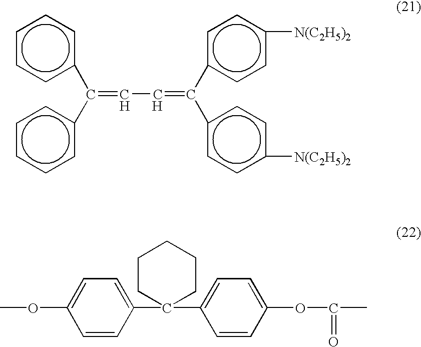

Then, 50 parts of the butadiene compound (21) (1,1-bis(p-diethylaminophenyl)-4,4-diphenyl-1,3-butadiene, manufactured by Takasago Chemical Corporation under the trade name of “T405”) shown above, 150 parts of the polycarbonate copolymer (compound No. 1) synthesized in Production Example 1, and 5 parts of 2,6-bis-tert-butyl-4-methylphenol (manufactured by Sumitomo Chemical Co., Ltd. under the trade name of “Sumilizer BHT”) were mixed with tetrahydrofuran as a solvent to prepare a coating liquid for forming surface protective layer having a solid content of 21% by weight. The coating liquid for forming surface protective layer was applied onto the surface of the charge transport layer in the same manner as in the case of the formation of the undercoat layer, and was dried at 110° C. for 1 hour to form a surface protective layer having a thickness of 5 μm. In this way, a multi-layered type electrophotographic photoreceptor having a structure shown in FIG. 8 was produced.

### Comparative Example 1

A multi-layered type electrophotographic photoreceptor was produced in the same manner as in Example 1 except that when a charge transport layer was formed, the polycarbonate copolymer (compound No. 1) synthesized in Production Example 1 was replaced with the polycarbonate copolymer synthesized in Comparative Production Example 1.

### Comparative Example 2

A multi-layered type electrophotographic photoreceptor was produced in the same manner as in Example 1 except that when a charge transport layer was formed, the polycarbonate copolymer (compound No. 1) synthesized in Production Example 1 was replaced with the polycarbonate copolymer synthesized in Comparative Production Example 2.

### Comparative Example 3

A multi-layered type electrophotographic photoreceptor was produced in the same manner as in Example 1 except that when a charge transport layer was formed, the polycarbonate copolymer (compound No. 1) synthesized in Production Example 1 was replaced with Z-type polycarbonate (manufactured by Mitsubishi Gas Chemical Company, Inc. under the trade name of “Iupilon Z400”).

(Image Evaluation)

Each of the multi-layered type electrophotographic photoreceptors produced in Examples 1 to 4 and Comparative Examples 1 to 3 was mounted to a test copier obtained by modifying a commercially available copier (manufactured by Sharp Corporation under the trade name of “AR-451N”) by replacing a charger with a charging roller, and then a halftone image was copied on 100,000 sheets. The condition of the image was evaluated at the initial stage of copying and after producing 100,000 copies.

Further, a developing device was demounted from the test copier at the initial stage of copying and after producing 100,000 copies, and a surface potential meter (manufactured by Trek under the trade name of “Model 1344”) was mounted to the developing position instead. Then, the surface potential V0 (V) of the photoreceptor at the time when a white solid image was copied and the surface potential VL (V) of the photoreceptor at the time when a black solid image was copied were measured to evaluate the electric characteristics of the photoreceptor.

(Durability Evaluation)

Each of the multi-layered type electrophotographic photoreceptors produced in Examples 1 to 4 and Comparative Examples 1 to 3 was mounted to a test copier obtained by modifying a commercially available copier (manufactured by Sharp Corporation under the trade name of “AR-451N”) by replacing a charger with a charging roller, and then an image was copied on 100,000 sheets. The total thickness of the layers provided on the conductive support of the electrophotographic photoreceptor was measured using a film thickness evaluation system (manufactured by Otsuka Electronics Co., Ltd. under the trade name of “MCPD 1100”) before and after producing 100,000 copies, and the thus measured total thicknesses were defined as T1 and T2, respectively. The amount of wear ΔT (T1-T2) was determined to evaluate the durability of the photoreceptor. It is to be noted that a larger amount of wear means lower durability.

Evaluation results are shown in table 1.

TABLE 1

| | | initial stage | | | after producing | | | |
|---|---|---|---|---|---|---|---|---|
| | | of copying | | | 100,000 copies | | | amount |
| | | | | condition | V0 | VL | condition | of wear |
| | | V0 (V) | VL (V) | of image | (V) | (V) | of image | μm |
| Ex. | 1 | −650 | −65 | good | −625 | −75 | good | 4.5 |
| | 2 | −650 | −65 | good | −630 | −80 | good | 4.7 |
| | 3 | −650 | −65 | good | −620 | −85 | good | 5.0 |
| | 4 | −650 | −70 | good | −630 | −80 | good | 4.0 |
| Com. | 1 | −650 | −65 | good | −630 | −75 | white dots | 4.5 |
| Ex. | | | | | | | appeared | |
| | 2 | −650 | −65 | good | −540 | −70 | fog appeared | 7.5 |
| | 3 | −650 | −65 | good | −590 | −75 | image density was | 5.5 |
| | | | | | | | increased | |

As can be seen from Table 1, in a case where the photoreceptors of Examples 1 to 3 whose charge transport layer contained the polycarbonate copolymer of Production Example and the photoreceptor of Example 4 whose surface protective layer contained the polycarbonate copolymer of Production Example were used, the condition of the image was good even after repeated use of the photoreceptor (i.e., even after producing 100,000 copies) and the amount of wear of the photoreceptor was small. Among these photoreceptors, in the case of the photoreceptor of Example 1 using the polycarbonate copolymer of Production Example 1 having a cyclohexane structure, the amount of wear was especially small. The reason for this can be considered as follows: the polycarbonate copolymer of Production Example 1 had excellent solubility in the solvent and therefore polymer chains thereof highly intertwined with each other so that a uniform and strong charge transport layer was formed.

On the other hand, in a case where the photoreceptors of Comparative Examples 1 and 2 using the polycarbonates of Comparative Production Examples and the photoreceptor of Comparative Example 3 using the commercially available polycarbonate were used, there were the following problems.

In a case where the photoreceptor of Comparative Example 1 was used, the condition of the image was good at the initial stage of copying, but after repeated use of the photoreceptor, white dots appeared in the image. The reason for this can be considered as follows: the charge transport layer was poor in flexibility and therefore a fine crack was formed in the charge transport layer due to repeated sliding contact with the cleaning blade and the developer, which interfered with charge transport. In a case where the photoreceptor of Comparative Example 2 was used, the amount of wear of the photoreceptor was large, the charging characteristics of the photoreceptor were significantly deteriorated, and fog appeared on the image. In a case where the photoreceptor of Comparative Example 3 whose charge transport layer contained the commercially available polycarbonate was used, the degree of change in image density was gradually increased as the amount of wear of the photoreceptor was increased due to repeated use because the test copier did not automatically control image density.

As described above, the electrophotographic photoreceptor of the present invention includes the aromatic polycarbonate copolymer having the structural units represented by the general formulas (1) to (3). The polycarbonate copolymer is excellent in mechanical strength, electric characteristics, and durability, and therefore the polycarbonate copolymer can be suitably used as a binder resin for forming a photosensitive layer of a single layer electrophotographic photoreceptor, a charge transport layer of a multi-layered type electrophotographic photoreceptor, and a surface protective layer of a single layer- or multi-layered type electrophotographic photoreceptor.

More specifically, the electrophotographic photoreceptor whose photosensitive layer or surface protective layer contains the polycarbonate copolymer described above has very high levels of various characteristics such as mechanical strength, electric characteristics, and durability (including wear resistance). Therefore, according to the present invention, it is possible to provide an electrophotographic photoreceptor whose film thickness is changed little and initial electric characteristics are hardly changed even after producing 100,000 or more copies and which is capable of stably forming high-quality images without image defects such as fog, black spots, and white spots.

Further, since the polycarbonate copolymer has an ether structure represented by the general formula (1), the electrophotographic photoreceptor of the present invention can have improved wear resistance without lowering flexibility.

Furthermore, according to the present invention, it is also possible to provide an image-forming apparatus including the electrophotographic photoreceptor described above, which has very high levels of various characteristics such as mechanical strength, electric characteristics, durability (including wear resistance) and image quality.

What is claimed is:

1. An electrophotographic photoreceptor comprising: a conductive support; and a photosensitive layer formed on the conductive support and contained at least a charge generation material and a charge transport material, wherein a surface layer of the photoreceptor contains a polycarbonate copolymer having structural units represented by the following general formulas (1) to (3): 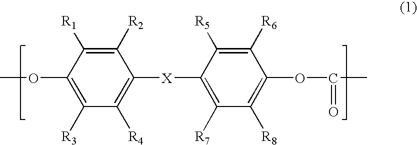
where X is oxygen atom or sulfur atom, R₁ to R₈ are hydrogen atom, a halogen atom, hydroxyl group, or an alkyl group having 1 to 4 carbon atoms; 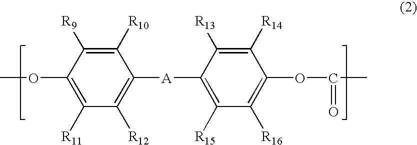
where A is a C₁ to C₁₀ linear, C₂ to C₁₀ branched, or C₃ to C₁₀ cyclic alkylidene group which may have an aryl group as a substituent, or an arylene group, and R₉ to R₁₆ are hydrogen atom, a halogen atom, nitro group, hydroxyl group, or an alkyl group having 1 to 4 carbon atoms; and

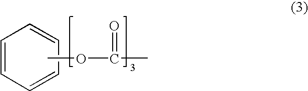

2. The electrophotographic photoreceptor according to claim 1, wherein the polycarbonate copolymer contains 5 to 9 mol % of the structural unit represented by the general formula (1), 86 to 94 mol % of the structural unit represented by the general formula (2), and 0.5 to 5 mol % of the structural unit represented by the general formula (3).

3. The electrophotographic photoreceptor according to claim 1, wherein the “A” is a C₃ to C₁₀ cyclic alkylidene group.

4. The electrophotographic photoreceptor according to claim 1, wherein the photosensitive layer is a multi-layered type photosensitive layer consisting of a charge generation layer and a charge transport layer, and the surface layer is the charge transport layer.

5. The electrophotographic photoreceptor according to claim 1, further comprising a surface protective layer formed on the photosensitive layer, and the surface layer is the surface protective layer.

6. The electrophotographic photoreceptor according to claim 1, wherein the polycarbonate copolymer has a number average molecular weight of 5,000 to 500,000.

7. The electrophotographic photoreceptor according to claim 1, wherein the polycarbonate copolymer has a structural unit represented by the general formula (1) wherein X is oxygen atom or sulfur atom and R₁ to R₈ are hydrogen atom, chlorine atom, methyl group, or ethyl group, a structural unit represented by the general formula (2) wherein A is cyclohexylidene group, isopropylidene group, phenylethylidene group, or cyclopentylidene group and R₉ to R₁₆ are hydrogen atom, chlorine atom, methyl group, or ethyl group, and an unsubstituted structural unit represented by the general formula (3).

8. The electrophotographic photoreceptor according to claim 1, wherein the polycarbonate copolymer has a weight average molecular weight of 5,000 to 500,000.

9. An image-forming apparatus comprising: the electrophotographic photoreceptor of claim 1; charging part for charging the electrophotographic photoreceptor; exposure part for forming an electrostatic latent image by irradiating the charged electrophotographic photoreceptor with light in accordance with image information; developing part for developing the electrostatic latent image formed on the electrophotographic photoreceptor into a visible image; and transfer part for transferring the visible image developed by the developing part onto a recording medium.

10. A polycarbonate copolymer for an electrophotographic photoreceptor having structural units represented by the following general formulas (1) to (3): 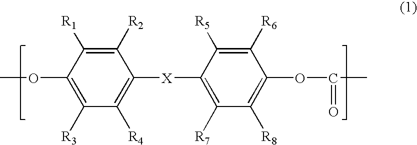
where X is oxygen atom or sulfur atom, R₁ to R₈ are hydrogen atom, a halogen atom, hydroxyl group, or an alkyl group having 1 to 4 carbon atoms; 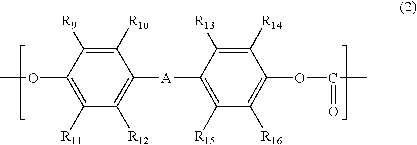
where A is a C₁ to C₁₀ linear, C₂ to C₁₀ branched, or C₃ to C₁₀ cyclic alkylidene group which may have an aryl group as a substituent, or an arylene group, and R₉ to R₁₆ are hydrogen atom, a halogen atom, nitro group, hydroxyl group, or an alkyl group having 1 to 4 carbon atoms; and [chemical structure]
